(19) United States
(12) Patent Application Publication
(10) Pub. No.: US 2023/0128484 A1
(43) Pub. Date: Apr. 27, 2023

(54) INTELLIGENT RADAR SYSTEMS AND METHODS

(71) Applicant: General Radar Corporation, Belmont, CA (US)

(72) Inventors: Dmitry Turbiner, Dallas, TX (US); Jon Williams, San Francisco, CA (US); Christian Kurzke, San Francisco, CA (US); Devin Matthews, San Francisco, CA (US); Ilia Lebedev, Cambridge, MA (US)

(21) Appl. No.: 17/805,120

(22) Filed: Jun. 2, 2022

Related U.S. Application Data
(60) Provisional application No. 63/195,725, filed on Jun. 2, 2021.

(51) Int. Cl. G01S 7/41; G01S 7/40

(52) U.S. Cl. CPC G01S 7/415; G01S 7/4004; G01S 2013/0245

(57) ABSTRACT

Aspects of the invention provide improvements to analyze data collected by a radar system. One of the systems includes a phased array module configured to transmit a sequence of pulses to an environment according to a pre-determined pattern. A data analysis system constructs an image based on returned signals from a single point received by the phased array module, and determines one or more characteristics of a target object in the environment based on the image constructed from the returned signals from the single point.

### CROSS-REFERENCE TO RELATED APPLICATIONS

This application claims benefit of U.S. Provisional Application No. 63/195,725, filed Jun. 2, 2021, the contents of which is hereby incorporated by reference in its entirety.

### BACKGROUND

Range-finding systems use reflected waves to discern, for example, the presence, distance and/or velocity of objects. Radio Detection And Ranging (radar) and other range-finding systems have been widely employed in applications, by way of non-limiting example, in autonomous vehicles such as self-driving cars, as well as in wireless communications modems of the type employed, such as in Massive-MIMO (multiple-in-multiple-out) networks, 5G wireless telecommunications, all by way of non-limiting example.

In recent years, radar is finding increasing use in automobiles for applications such as blind-spot detection, collision avoidance, and autonomous driving. Compared to other means of detecting obstacles (LIDAR, cameras, etc.), millimeter-wave radar is relatively unaffected by rain, fog, or backlighting, which makes it particularly suitable for low-visibility nighttime and bad weather. However, the existing automotive radar technology may lack the required resolution to sense different objects, distinguish between closely spaced objects, or detect characteristics of objects on the road or in the surrounding environment. The resolution of existing automotive radar systems may be limited in both azimuth and elevation. Additionally, existing automotive radar systems may have limited capability of processing and fully exploring the rich radar data for providing real-time information.

### SUMMARY

The present disclosure provides high resolution millimeter-wave radar systems that can address various drawbacks of conventional systems, including those recognized above. Radar systems of the present disclosure can be utilized in a variety of fields such as vehicle navigation and autonomous driving. A radar system of the present disclosure is advantageously able to perform object recognition, obstacle detection or range-finding with improved accuracy, resolution and response time. Moreover, radar systems disclosed herein are capable of building a 3D point cloud of a target object in real time, that is, the provided radar systems can be used for three-dimensional (3D) imaging (e.g., 3D point cloud) or detecting obstacles. The provided radar systems may be an intelligent radar system. The intelligent radar system may be equipped with an improved data processing module that is configured to generate images from single-point radar returns that are suitable for classification by machine learning techniques. This allows sophisticated object properties and other knowledge about the object to be automatically generated even when the object is far away and can only be illuminated by a single beam. The improved data processing model can also automate data processing, including, for example, data creation, data cleansing, data enrichment, information/inference extraction at various levels and delivering data and knowledge across data centers, systems, and third-party entities with proprietary algorithms designed for radar data.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an example radar system having the above mentioned functionalities.

FIG. 2 shows an example of 3D point cloud image generated by the radar system in real time

FIG. 3 schematically illustrates a radar system capable of providing an enriched 3D point cloud image and performing single point object recognition.

FIG. 4 shows an example of object recognition using single point data.

FIG. 5 and FIG. 6 show examples of different objects demonstrating different phase properties in response to a sequence of frequency modulated radar signals.

FIG. 7 shows an example of performing threat detection using a predictive model, in accordance with some embodiments of the invention.

FIG. 8 is a flowchart of an example process for using single-point spectral property images for classifying an object.

FIG. 9 is a flowchart of an example process for training a machine learning model to derive information from spectral properties of images.

The patent or application file contains at least one drawing executed in color. Copies of this patent or patent application publication with color drawing(s) will be provided by the Office upon request and payment of the necessary fee.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

A radar system of the present disclosure is advantageously able to perform object recognition, obstacle detection or range-finding with improved accuracy, resolution and response time. Moreover, radar systems disclosed herein are capable of building a 3D point cloud of a target object in real time, that is, the provided radar systems can be used for three-dimensional (3D) imaging (e.g., 3D point cloud) or detecting obstacles. An intelligent radar system as provided herein may be equipped with an improved data processing module that is configured to automate data processing, including, for example, data creation, data cleansing, data enrichment, information/inference extraction at various levels and delivering data and knowledge across data centers, systems, and third-party entities with proprietor algorithms designed for radar data

Real-time, as used herein, generally refers to a response time of less than 1 second, tenth of a second, hundredth of a second, a millisecond, or less, such as by a computer processor. Real-time can also refer to a simultaneous or substantially simultaneous occurrence of a first event with respect to occurrence of a second event.

In some embodiments, the radar data may be pre-processed or prepared by the radar system such that it can quickly and easily be accessed via APIs by intended data consumers or applications. In some cases, the application may include a machine learning-based architecture that may analyze the radar data on-board the radar system or externally to interpret one or more objects detected by the radar system in an environment.

In some embodiments, the provided radar system may be a millimeter wave radar that emits a low power millimeter wave operating at 76-81 GHz (with a corresponding wavelength of about 4 mm) or other suitable band that is below 76 GHz (e.g., any center frequency with a single-sided band having a bandwidth of up to 14 GHz, double-sided band with bandwidth of up to 28 GHz, narrowband radar such as unlicensed ISM bands at 24 GHz, wideband such as unlicensed Part 15) or above 81 GHz.

The radar system may be configured to determine the presence, distance, velocity and/or other physical characteristics of objects using radio frequency pulses. In some embodiments, the radar system may be capable of building a three-dimensional (3D) point cloud of a target object in real time, that is, the provided radar systems can be used for 3D imaging (e.g., 3D point cloud) or detecting obstacles. The real-time point cloud image data can be produced by a proprietary data processing algorithm with improved efficiency.

In some embodiments, in addition to spatial positional information, each point (e.g., voxel) in the 3D point cloud may be enriched with information about the characteristics of the object. Such information may be an object signature of a target, depending on the object's composition (e.g., metal, human, animal), materials, volumetric composition, reflectivity of the target and the like. The object signature is a more detailed understanding of the target, which may give dimensions, weight, composition, identity, degree of threat and so forth. In some embodiments, such object signature information may be generated by a predictive model. In some embodiments, such object signature information may be generated based on a reduced dataset. For instance, material of a given point may be identified based on single point radar signals reflected off that given point and the 3D point cloud may be augmented with object signature information in substantially real time.

In some embodiments, the radar system disclosed herein can also provide object recognition with improved accuracy and efficiency. The radar system may employ a predictive model to process the returned signal and extract information from a single point measurement signal. The predictive model may be built using machine learning techniques. In some cases, one or more physical characteristics of a target object such as the materials or volumetric/geometric composition (e.g., laminated plastic/metal bumpers, tires, etc) can be recognized in real-time with the aid of the machine learning model.

The returned signal or raw radar data received by the radar system may contain information about the characteristics or object signature. Such characteristics or object signature information may be elicited by modulating the transmitted signal, e.g., varying the frequency within each pulse or by coding the phase of a continuous-wave signal (digitalized and correlated by a correlator). In some embodiments, pulse compression may be employed for modulating the transmitted signal. Pulse compression can also provide improved signal strength of longer, lower-power pulses with the improved resolution of shorter pulses. For example, by embedding a known a-priori pattern into each pulse, the arrival time of its reflection-and, therefore, the range of the object from which that reflection has occurred-can be resolved with greater precision by finding the point of highest correlation between the pulse pattern and the incoming reflection signals. In other words, very fine range resolution can be achieved with long pulse durations.

The radar system may achieve higher resolution by improving azimuth resolution, elevation resolution, or any combination thereof. Azimuth resolution is the ability of a radar system to distinguish between objects at similar range but different bearings in the azimuth plane. Elevation resolution is the ability of a radar system to distinguish between objects at similar range but different elevation. Angular resolution characteristics of a radar are determined by the antenna beam-width represented by the −3 dB angle which is defined by the half-power (−3 dB) points. In some embodiments, the radar system disclosed herein may have a −3 dB beam-width of 1.5 degree or less in both azimuth resolution and elevation resolution. In some embodiments, the radar system can be configured to achieve finer azimuth resolution and elevation resolution by employing an RF front- end device having two linear antennas arrays arranged perpendicularly as well as utilizing a high-speed ADC (analog to digital converter)/DAC (digital to analog converter) for digitalized pulse compression.

In some embodiments, the ADC/DAC logic is implemented using a serializer/deserializer (“SERDES”) thereby providing a low-cost, compact and efficient signal correlator. The SERDES has a receive side (a/k/a the “deserializer”) with an input to which an “analog” signal is applied. The SERDES generates and applies, to a correlation logic within a correlator, digital samples of the analog signal. Utilizing SERDES advantageously provides low timing noise and high sampling rates (e.g., 28 Gb/sec) thereby allowing for a low-cost radar system with improved resolution and high processing speed.

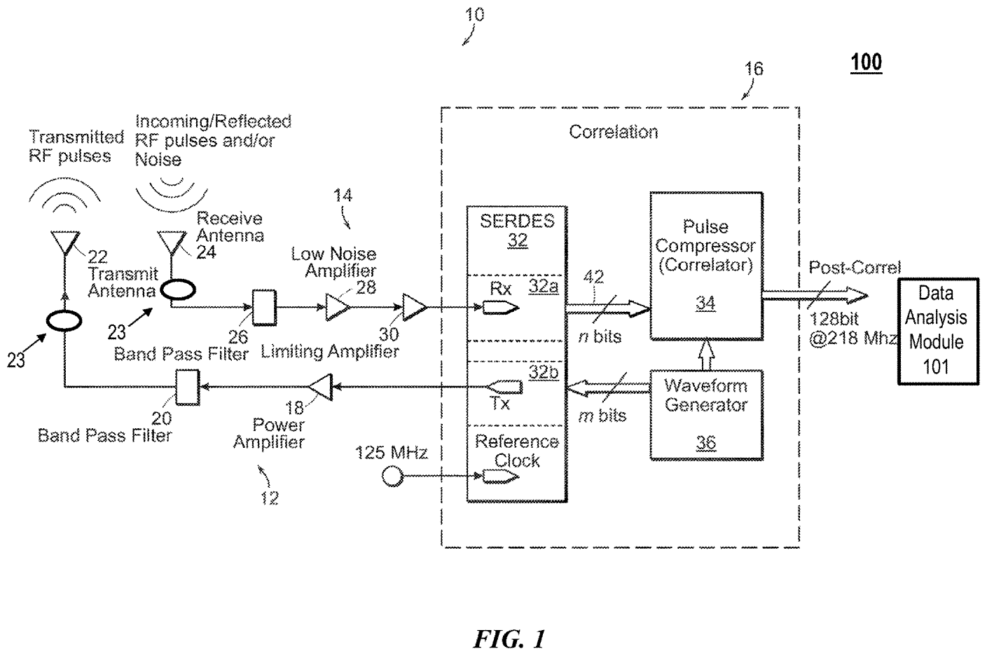

FIG. 1 shows an example radar system 100, in accordance with some embodiments of the invention. In some embodiments, the radar system 100 may include a millimeter wave radar that emits a low power millimeter wave operating at 76-81 GHz (with a corresponding wavelength of about 4 mm). The radar system can also operate at other frequency range that is below 76 GHz (e.g., any center frequency with a single-sided band having a bandwidth of up to 14 GHz, double-sided band with bandwidth of up to 28 GHz, narrowband radar such as unlicensed ISM bands at 24 GHz, wideband such as unlicensed Part 15) or above 81 GHz.

The radar system may comprise any one or more elements of a conventional radar system, a phased array radar system, an AESA (Active Electronically Scanned Array) radar system, a synthetic aperture radar (SAR) system, a MIMO (Multiple-Input Multiple-Output) radar system, and/or a phased-MIMO radar system. A conventional radar system may be a radar system that uses radio waves transmitted by a transmitting antenna and received by a receiving antenna to detect objects. A phased array radar system may be a radar system that manipulates the phase of one or more radio waves transmitted by a transmitting and receiving module and uses a pattern of constructive and destructive interference created by the radio waves transmitted with different phases to steer a beam of radio waves in a desired direction.

The radar system 100 may be provided on a movable object to sense an environment surrounding the movable object. Alternatively, the radar system may be installed on a stationary object.

A movable object can be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle, bicycle; a movable structure or frame such as a stick, fishing pole; or a train), under the ground (e.g., a subway), in space (e.g., a spaceplane, a satellite, or a probe), or any combination of these environments. The movable object can be a vehicle, such as a vehicle described elsewhere herein. In some embodiments, the movable object can be carried by a living subject, or take off from a living subject, such as a human or an animal.

In some cases, the movable object can be an autonomous vehicle which may be referred to as an autonomous car, driverless car, self-driving car, robotic car, or unmanned vehicle. In some cases, an autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

In some instances, the radar systems may be integrated into a vehicle as part of an autonomous-vehicle driving system. For example, a radar system may provide information about the surrounding environment to a driving system of an autonomous vehicle. An autonomous-vehicle driving system may include one or more computing systems that receive information from a radar system about the surrounding environment, analyze the received information, and provide control signals to the vehicle's driving systems (e.g., steering wheel, accelerator, brake, or turn signal).

The radar system 100 may be used on a vehicle to determine a spatial disposition or physical characteristic of one or more targets in a surrounding environment. The radar system may advantageously have a built-in predictive model for object recognition or high-level decision making. For example, the predictive model may determine one or more properties of a detected object (e.g., materials, volumetric composition, type, color, etc) based on radar data. Alternatively or in addition to, the predictive model may run on an external system such as the computing system of the vehicle.

The radar system may be mounted to any side of the vehicle, or to one or more sides of the vehicle, e.g. a front side, rear side, lateral side, top side, or bottom side of the vehicle. In some cases, the radar system may be mounted between two adjacent sides of the vehicle. In some cases, the radar system may be mounted to the top of the vehicle. The system may be oriented to detect one or more targets in front of the vehicle, behind the vehicle, or to the lateral sides of the vehicle.

A target may be any object external to the vehicle. A target may be a living being or an inanimate object. A target may be a pedestrian, an animal, a vehicle, a building, a sign post, a sidewalk, a sidewalk curb, a fence, a tree, or any object that may obstruct a vehicle travelling in any given direction. A target may be stationary, moving, or capable of movement.

A target object may be located in the front, rear, or lateral side of the vehicle. A target object may be positioned at a range of about 1, 2, 3, 4, 5, 10, 15, 20, 25, 50, 75, or 100 meters from the vehicle. A target may be located on the ground, in the water, or in the air. A target object may be oriented in any direction relative to the vehicle. A target object may be oriented to face the vehicle or oriented to face away from the vehicle at an angle ranging from 0 to 360 degrees.

A target may have a spatial disposition or characteristic that may be measured or detected. Spatial disposition information may include information about the position, velocity, acceleration, and other kinematic properties of the target relative to the terrestrial vehicle. A characteristic of a target may include information on the size, shape, orientation, volumetric composition, and material properties, such as reflectivity, material composition, of the target or at least a part of the target. In some embodiments, the spatial disposition information may be used to construct a 3D point cloud image. In some embodiments, at least a portion of the characteristics of the target may be obtained with the aid of a predictive model. The characteristics may be used to augment the 3D point cloud image by enriching each point with characteristic or object signature information (e.g., materials). Alternatively or in addition to, the characteristics may be used for higher-level decision making (e.g., threat determination, identity recognition, object classification) or utilized by third-party entities.

A surrounding environment may be a location and/or setting in which the vehicle may operate. A surrounding environment may be an indoor or outdoor space. A surrounding environment may be an urban, suburban, or rural setting. A surrounding environment may be a high altitude or low altitude setting. A surrounding environment may include settings that provide poor visibility (night time, heavy precipitation, fog, particulates in the air). A surrounding environment may include targets that are on a travel path of a vehicle. A surrounding environment may include targets that are outside of a travel path of a vehicle. A surrounding environment may be an environment external to a vehicle.

Referring to FIG. 1, in some embodiments, the radar system 100 may include a phased array module 10. Returned signal may be processed by a correlator of the radar system 24 and the processed data (e.g., post correlated data) may further be processed by a data analysis module 101 for object recognition, constructing point cloud image data and other analysis.

The radar system may be a high-speed digital modulation radar. In some embodiments, a phased array module 10 may comprise a transmit logic 12, receive logic 14 and correlation logic 16 illustrated in FIG. 1. The phased array module and the signal correlator may include those described in U.S. Pub. No. 2018/0059215 entitled “Beam-Forming Reconfigurable Correlator (Pulse Compression Receiver) Based on Multi-Gigabit Serial Transceivers (SERDES)”, which is incorporated by reference herein in its entirety.

For example, the transmit logic 12 may comprise componentry of the type known in the art for use with radar systems (and particularly, for example, in pulse compression radar systems) to transmit into the environment or otherwise a pulse based on an applied analog signal. In the illustrated embodiment, this is shown as including a power amplifier 18, band pass filter 20 and transmit antenna 22, connected as shown or as otherwise known in the art.

The receive logic 14 comprises componentry of the type known in the art for use with RADAR systems (and particularly, for example, in pulse compression RADAR systems) to receive from the environment (or otherwise) incoming analog signals that represent possible reflections of a transmitted pulse. Those signals may often include (or solely constitute) noise. In the illustrated embodiment, the receive logic includes receive antenna 24, band pass filter 26, low noise amplifier 28, and limiting amplifier 30, connected as shown or as otherwise known in the art.

The correlation logic 16 correlates the incoming signals, as received and conditioned by the receive logic 14, with the pulse transmitted by the transmit logic 12 (or, more aptly, in the illustrated embodiment, with the patterns on which that pulse is based) in order to find when, if at all, there is a high correlation between them. Illustrated correlation logic comprises serializer/deserializer (SERDES) 32, correlator 34 and waveform generator 36, coupled as shown (e.g., by logic gates of an FPGA or otherwise) or as otherwise evident in view of the teachings hereof.

Each of elements 32-36 may be stand-alone circuit elements; alternatively, one or more of them may be embodied in a common FPGA, ASIC or otherwise. Moreover, elements 32-36, or any one or more of them, may be embedded on a common FPGA, ASIC or other logic element with one or more of the other elements discussed above, e.g., elements 12-30. When embodied in FPGAs, ASICs or the like, the elements 32-36 provide for sampling and processing of incoming signals at rates of at least 3 giga samples per second (GSPS) and, preferably, at a rate of at least 28 GSPS.

The waveform generator 36 generates a multi-bit digital value of length m (which can be, for example, a byte, word, longword or so forth) embodying a pattern on which pulses transmitted by transmit logic 12 are (to be) based. In some implementations, this is a static value. In others, it is dynamic in that it changes periodically or otherwise. The dynamic value can be a value from a pseudo random noise sequence (PRN), although, those skilled in the art will appreciate that other dynamic values, e.g., with suitable autocorrelation properties, can be used instead or in addition.

The pattern may include a bit pattern according to which the transmitted signal is coded (e.g., frequency modulated). An example of a multi-bit value—or “bit pattern”—generated by the generator 36 is a digital value such as “111000110010,” where the 1's indicate when the pulse is “on,” and the 0's indicate when the pulse is “off.” The pattern embodied in this digital value defines a “chirp” pulse, that is, a pulse that is “on” and “off” for shorter and shorter time periods-here, for illustrative purposes only, on for three ticks, off for three ticks, on for two ticks, off for two ticks, on for one tick and off for one tick (all by way of example), where “tick” refers to a moment of generic length, e.g., a microsecond, a millisecond or so forth. Various other patterns of modulating frequencies can be employed that may or may not conform to a chirp pulse.

The provided radar system or phased array module may allow for transmitting a pre-determined sequence of signals having multiple frequencies. Below is an example of a sequence of signals having multiple frequencies: 010101 . . . 001100110011 . . . 000111000111 . . .

The abovementioned multi-frequency signals may be directed to a single point in space. In some cases, a sequence of such multi-frequency signals may be used as single point measurement signals for eliciting time delay, amplitude, and/or phase information of a point in space or a target object as described elsewhere herein.

The components of different frequencies may be transmitted sequentially or concurrently. The components of various frequencies may be transmitted by a single element of the antennas array or multiple elements of the antennas array. The correlator may implement a time domain algorithm and/or a frequency domain algorithm to analyze the signals in both time domain and frequency domain thereby extracting characteristics such as the time delay, amplitude and/or phase information of a point in space.

The illustrated logic 16 may include a serializer deserializer 32 (SERDES) of the type known in the art, as adapted in accord with the teachings hereof. SERDES 32 may be a stand-alone electronic circuit element or one that is embedded, e.g., as an interface unit, in a general- or special-purpose circuit element, e.g., a field programmable gate array (FPGA), an application specific integrated circuit (ASIC), and so forth. In the illustrated embodiment, SERDES 32 is shown as forming part of the correlation unit 16, e.g., along with the pulse compressor 34 and waveform generator 36, and, indeed, in some embodiments, those units reside on a common FPGA (or ASIC). In other embodiments the SERDES 32 may be packaged separately from one or both of those units 34, 36.

The SERDES 32 may include a deserializer 32a (a/k/a a “receive side”) and a serializer 32b (a/k/a a “transmit side”), each with an input and an output. Those inputs and outputs may be leads (e.g., in the case of a stand-alone SERDES), logic paths (in the case of a SERDES embedded in an FPGA) or the like, as is common in the art.

The deserializer 32a can be of the type commonly known in the art for accepting a digital signal at its input and converting it to a digital signal of another format at its output, e.g., by “parallelizing” (a/k/a “deserializing”) or grouping bits that make up the input signal (for example, converting a stream of bits into a byte, word or longword).

The deserializer 32a may be coupled to receive logic 14, e.g., as shown in FIG. 1, to accept as input signals 38 representing possible reflections of the pulse from objects in the range and path of the range-finding system 10. Those signals 38 might conventionally be considered to be “analog” signals given the manner in which they are received from the environment and processed by the elements of the receive logic 14—esp., for example, in a system 10 in which elements 18-22 are of the type known in the art of radar.

The deserializer 32a, however, accepts those “analog” signals at its input as if they were digital and, particularly, in the illustrated embodiment, as if they were a stream of bits, and it groups those bits, e.g., into longwords, at its output. As used herein, the term “longword” refers not only to 32-bit words, but to any multi-bit unit of data. In some preferred embodiments, these are 128-bit words (a/k/a “octawords” or “double quadwords”), but in other embodiments they may be nibbles (4 bits), bytes (8 bits), half-words (16 bits), words (32 bits) or any other multi-bit size.

The deserializer 32a of the illustrated embodiment, thus, operates as a 1-bit ADC (that is, as an analog to digital converter) that, in effect, samples and converts an incoming “analog” signal (received at its input) representing possible reflections of the pulse into a stream of longwords (produced at its output), where the sampling is only for two amplitudes: high (amplitude 1) and low (amplitude 0). The longwords in that stream, thus, embody bit-patterns representing those possible reflections.

Like the deserializer 32a, the serializer 32b can be of the type commonly known in the art for accepting a digital signal at its input and converting it to a digital signal of another format at its output, e.g., by serializing or un-grouping bits that make up the input signal (for example, converting an byte, word or longword into a stream of its constituent bits).

The input of the serializer 32b may be coupled to the waveform generator 36, which applies to that input a word, long word or other multi-bit digital value embodying a pattern on which pulses transmitted by transmit logic 12 are (to be) based. The serializer 32b serializes or ungroups the multi-bit value at its input and applies it, e.g., as a stream of individual bits, to the transmit logic 12 and, more particularly, in the illustrated embodiment, the power amplifier 18, to be transmitted as a pulse into the environment or otherwise.

Those skilled in the art will appreciate that an analog signal would conventionally be applied to transmit logic 12 for this purpose. The serializer 32b, however, applies its digital output to the logic 12 (here, particularly, the amplifier 18) to be treated as if it were analog and to be transmitted into the environment or otherwise as pulses.

The serializer 32b of the illustrated embodiment, thus, effectively operates as a 1-bit DAC (digital to analog converter) that converts a digital signal applied to it by the waveform generator 36 into a stream of individual bits and that it applies to the transmit logic 12 as if it were an analog signal for amplification and broadcast as pulses by the transmit antenna 22.

The correlator 34 correlates the bit-pattern that is embodied in the multi-bit digital value from waveform generator 36 embodying the pattern(s) on which pulses transmitted by transmit logic 12 are based with the bit-patterns representing possible reflections of the pulse embodied in digital stream of longwords produced by the deserializer 32 a from the input signal 38. To this end, the correlator 34 searches for the best match, if any, of the pulse bit-pattern (from generator 36) with the bit-patterns embodied in successive portions of the digital stream (from the deserializer 32a) stored in registers that form part of the correlator (or otherwise).

The aforementioned SERDES may be implemented in any of an ASIC or an FPGA. In the illustrated example, the SERDES functions as a 1-bit Digital-To-Analog Converter/Analog-to-Digital Converter operating at 28 giga samples per second (GSPS), and the correlator is capable of operating at 10 GSPS.

In some embodiments, a phased array module 10 may include a phase shifting network in the RF front-end device. In some embodiments, the phase shifting network may be implemented using a Rotman lens. As shown in FIG. 1, a Rotman lens 23 may be interposed between the transmit logic and the array of multiple transmit antennas 22. In some cases, the RF front-end device may comprise a phase shifting network, such as the Rotman lens, and a linear antennas array.

The Rotman lens 23 may include a plurality of beam ports coupled to a main body across from a plurality of array ports. If one of the beam ports is excited, the electromagnetic wave will be emitted in the cavity space and reach the array ports. The shape of contour that array ports have laid on it and the length of transmission lines are determined so that a progressive phase taper is created on array elements; and thus a beam is formed at a particular direction in the space.

The Rotman lens can be implemented using waveguides, microstrip, stripline technologies or any combination of the above. In some embodiments, the Rotman lens may be a microstrip-based Rotman lens. In some embodiments, the Rotman lens may be a waveguide-based Rotman lens. In some cases, waveguides may be used in place of transmission lines.

In some embodiments, the radar antenna array may have a spatial configuration that may involve a fixed spatial configuration between adjacent transmit and/or receive antennas. The radar antenna array may comprise a transmit antenna and a receive antenna arranged in a fixed spatial configuration relative to one another. In some embodiments, the transmit and receive antenna may be arranged so that they are in the same plane. In other embodiments, the transmit and receive antenna may not be on substantially the same plane. For example, the transmit antenna may be on a first plane and the receive antenna may be on a second plane. The first plane and second plane may be parallel to one another. Alternatively, the first and second planes need not be parallel, and may intersect one another. In some cases, the first plane and second plane may be perpendicular to one another.

The perpendicularly arranged antenna arrays can have various working configurations. For example, in some cases, one of the two antenna arrays may be used for azimuth scanning while the other perpendicularly positioned antenna array may be used for elevation scanning. In other cases, one of the antenna arrays may be used for transmitting signals while the other perpendicularly positioned antenna array may be used for receiving signals. In some cases, the different working configurations may be controlled by a controller of the radar system.

The radar system may provide a wide range of scan angles. By employing the Rotman lens, a fast-speed SERDES as ADC/DAC and the perpendicular configuration of the front-end device, the radar system may provide benefits of achieving a large field of view or greater resolution. In some cases, the provided radar system may be capable of achieving a 90 degree azimuth field of view and 90 degree elevation field of view with a 1 degree angular resolution in both directions.

A radar system described herein may comprise at least 2, 3, 4, 5, 6, 7, 8, 9, 10 or more phased array modules stacked together. A phased array module may comprise at least 1, 2, 3, 4, 5, 6, 7, 8, 9, 10 or more SERDES channels.

The radar system described herein may be capable of performing real-time point cloud imaging. In some cases, the radar system can be used for three-dimensional (3D) imaging (e.g., 3D point cloud) or detecting obstacles. In some cases, a distance measurement can be considered a pixel, and a collection of pixels emitted and captured in succession (i.e., “point cloud”) can be rendered as an image or analyzed for other reasons (e.g., detecting obstacles, object recognition, threat determination, etc).

A radar system can perform an image formation process using one or more image formation algorithms to create two-dimensional (2D) or three-dimensional (3D) images using a plurality of signals received by the radar antenna array. The plurality of signals may contain data such as phase measurements at one or more transmitting and/or receiving antennas in a radar antenna array. An image formation process can use a time domain algorithm and/or a frequency domain algorithm. A time domain algorithm is an algorithm that constructs an image of one or more targets by performing calculations with respect to the timing of the plurality of signals transmitted and/or received by the radar antenna array with aid of a correlator as described above. A frequency domain algorithm is an algorithm that constructs an image of one or more targets by performing calculations with respect to the frequency of the plurality of signals transmitted and/or received by the radar antenna array. Time domain algorithms may use a matched filtering process to correlate one or more radar pulses transmitted by the radar antenna array and/or transmitting antenna with one or more signals received by the radar antenna array and/or receiving antenna. The image construction may be based on data processed by the pulse compression method as described above.

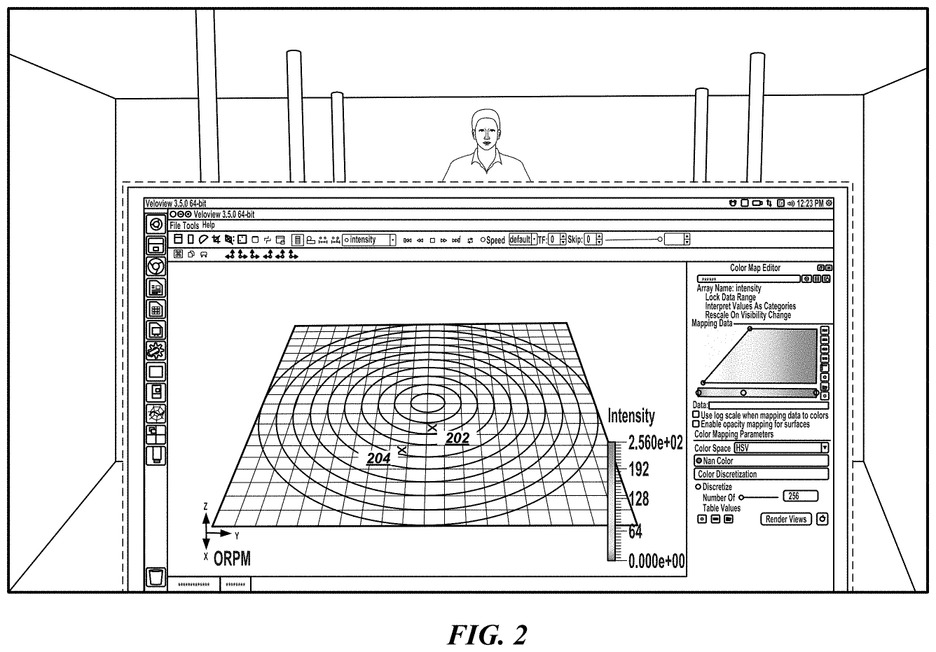

FIG. 2 shows an example of a 3D point cloud image generated by the radar system in real time. The 3D point cloud image may be produced using the signals received by the antennas array as described above. The 3D point cloud image may display information about a spatial disposition of one or more targets in a surrounding environment. In some cases, the 3D point cloud image may have a voxel size of 1 degree×1 degree×1.5 cm. In some embodiments, physical characteristics of the one or more targets may be extracted from the same set of radar data with aid of the aforementioned data analysis module. In this example, two points 202 and 204 are shown as representing reflections off objects in the environment.

In some embodiments, in addition to spatial positional information, each point (e.g., voxel) in the 3D point cloud may be enriched with information about the characteristics of the object. Such information may be an object signature of a target, depending on the object's composition (e.g., metal, human, animal), materials, volumetric composition, reflectivity of the target and the like. The object signature is a more detailed understanding of the target, which may give dimensions, weight, composition, identity, degree of threat and so forth. In some embodiments, such information may be generated by the data analysis module.

In some embodiments, such object signature information may be generated based on a reduced radar dataset such as a single point measurement signal. For instance, material of a given point in space may be identified based on the single point measurement signal corresponding to that given point thereby the 3D point cloud can be augmented with object signature information in substantially real time. A single point measurement signal may refer to returned signals corresponding to a single point in space which may comprise a sequence of light pulses reflected off a point in space. Alternatively or in addition to, a single point measurement signal may refer to characteristics such as time delay, amplitude and/or phase information extracted from a sequence of returned signals using the algorithms/methods (e.g., correlation) as described above. As described above, the sequence of returned signals may correspond to a sequence of signals transmitted according to a pattern. The sequence of returned signals may be analyzed against the pattern to extract characteristics such as the time delay, amplitude and/or phase information using the algorithms/methods (e.g., correlation). For example, the characteristics may be elicited by modulating the transmitted signal, e.g., varying the frequency within each pulse or by coding the phase of a continuous-wave signal (digitalized and correlated by the correlator as described above).

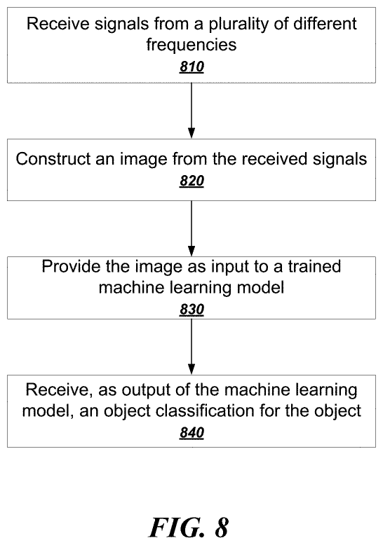

FIG. 8 is a flowchart of an example process for using single-point spectral property images for classifying an object. In this specification, a spectral properties image, or, for brevity, an image, is a two-dimensional collection of the spectral properties of radar return data. In some implementations, the two dimensions correspond to frequency and a range gate, or, equivalently, a gated return time. When generating a spectral properties image, the radar system can collect all data for the image using substantially the same angular direction (azimuth) and elevation while varying the transmission frequency. Generating an image from spectral properties in this way reveals features about the observed object that arise from relationships between time and frequency in the spectral properties of radar return data in a way that is suitable for further analysis by machine learning models, e.g., convolutional neural networks. This capability allows the radar system to derive unprecedented and sophisticated information about targets that are smaller than a single beam width and which can thus only be illuminated by a single beam.

The example process can be performed by a system having one or more computers that is programmed in accordance with this specification to process radar signal data. For convenience, the process will be described as being performed by a system of one or more computers.

The system receives signals of multiple frequencies for a single point (810).

Typically the radar return data for an image is collected from a single illumination point.

In some embodiments, the distance and location of the object can be determined based on a first return from a radar. The object can be determined as a target for further analysis based on the first return. Alternatively or in addition, the system can continually generate and analyze images for a plurality of locations in the environment. A radar beam, e.g., with range, time, frequency, codes, and pulse-waveforms, can be transmitted as an illuminating waveform. The received signals from the plurality of different frequencies can correspond to the returns from the transmitted radar beam. The signals can, for example, be received from a single point by the phased array module 10 of FIG. 1. For example, a single point can be a single angular direction relative to the phased array module 10. The angular width of the target can be smaller than the width of the beam.

In some embodiments, the signals to be used in constructing an image are based on a range gate. The range gate can be determined based on a time of flight of the beam. The time of flight can be determined based on the returned radar signals and the speed of light in a current medium. For example, the time of flight of the beam can be calculated as 6689 ns (nanoseconds) for a target, meaning that the target is 1 km away (i.e., 2 km round trip distance). For an example radar system using a sampling rate of 20 GSPS, the range gate can be set for a period of 50 ns in order to collect 1000 samples. The radar system can analyze half a waveform long of range points before the central point and half afterwards. For example, the range gate can begin at 6664 ns (6689−25) after the beam is transmitted and end at 6714 ns (6689+25) in order to collect 1000 samples centered in range on the target.

Values can be determined for each of the plurality of different frequencies in the received signal at each sample point in the range gate. Therefore, for a single frequency, the system will generate a plurality of different sample values, which can, for example, represent signal strength or a signal-to-noise ratio of the corresponding sample. The frequencies in each sample can be normalized and indexed in order to create a vector for each sample point including the normalized values (e.g., signal strength, phase shift, frequency modulation) at each index. A matrix can be created by grouping all of the normalized values from all of the samples in the range gate.

The system constructs from the received signals (820). As described above, the image has at least two dimensions corresponding to frequency and time or, equivalently, distance or sample number. In some implementations, the system arranges one axis of the image according to values of the different frequencies or an index value of a plurality of different frequencies. The image need not be constructed using ordered frequencies, but for some applications, more features can be extracted from the object when the frequencies are in order so that the spatial locality of the image reveals information about features that interact with closely related frequencies.

The image can be constructed from the matrix of normalized values. For example, values for each pixel, e.g., brightness and color, can be used to represent the different normalized values at each location in the matrix. The image can correspond to the electromagnetic time and frequency interactions of the target with the transmitted radar beam. The image may be constructed using an image formation algorithm.

In some implementations, the system centers the image using the range gate. I.e. the center-most values correspond to returns in the middle of the range gate, and values to the left and right correspond to a half width of the range gate.

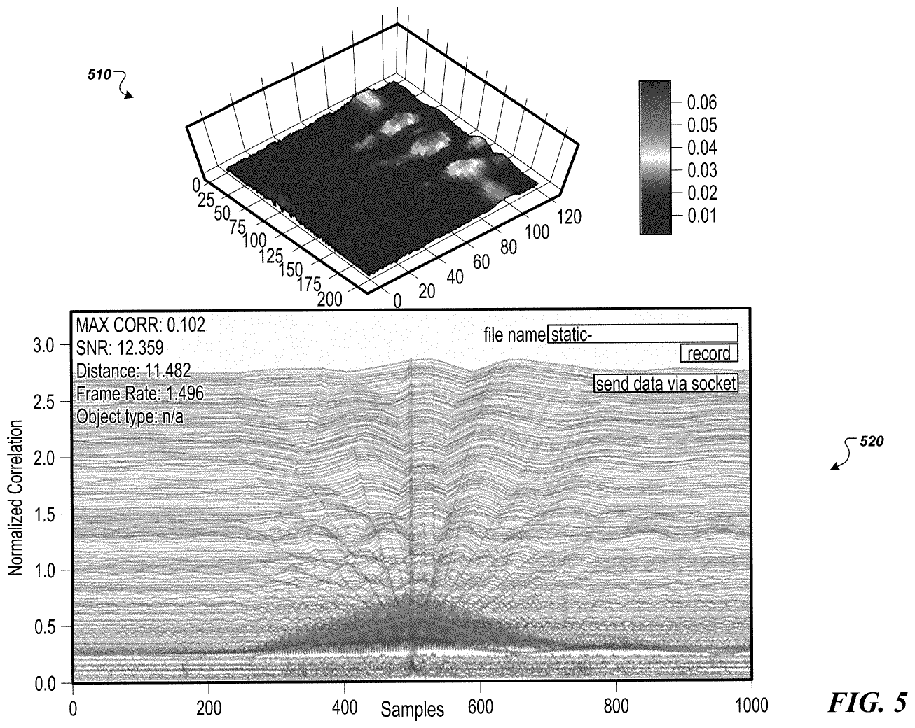

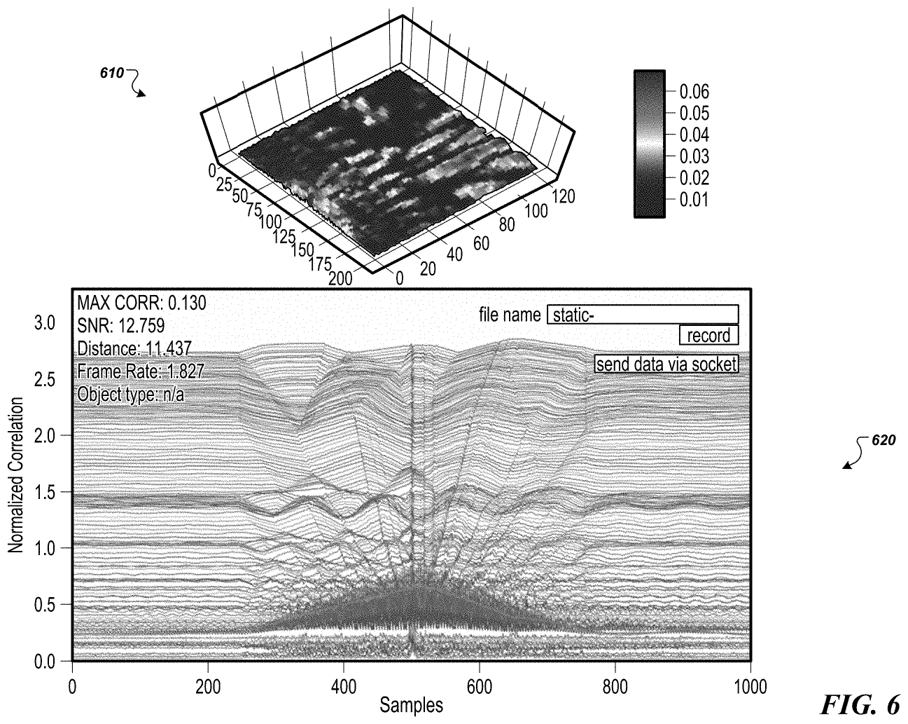

FIG. 5 and FIG. 6 illustrate example images constructed from received signals from a single point target. The images show examples of different objects presenting different phase properties in response to a sequence of frequency modulated radar signals. The single point measurement signal may be processed by the data analysis module to identify one or more characteristics or object signatures. In some embodiments, the data analysis module can employ a predictive model to process the returned signal and extract information from a single point measurement signal.

In FIG. 5, a 3D plot 510 illustrates the information contained within an image generated from a single point target. The x and y axes represent sample numbers in time and frequency respectively. The z-axis represents the spectral properties corresponding to those sample number and frequency coordinates. In some implementations, the axis for the frequency is an index number rather than an actual frequency value. For example, in the top plot 5A, the frequency values range over indexes 0 to 120.

The bottom plot 520 illustrates the same information in a different way. The x-axis represents samples in time, or effectively, range, and the y-axis represents frequency. The lines across the plot represent spectral properties corresponding to those sample and frequency coordinates, which is the information represented in the image generated from radar returns.

FIG. 6 illustrates another example for a different type of object than in FIG. 5. FIG. 6 includes a 3D plot 610 that illustrates the information encoded in an image generated from radar returns, and the bottom plot 620 illustrates the same information with a different visualization of the spectral properties according to sample number and frequency. The generated image effectively correlates in two dimensions spectral properties according to time and frequency. It is apparent from FIGS. 5 and 6 that the spectral properties of the radar returns vary greatly for the different object, which is information that can be learned by a machine learning model in order to automatically generated sophisticated object characteristics from radar returns at a single point.

As shown in FIG. 8, the system provides the generated image as input to a trained machine learning model (830). The trained machine learning model can be configured to classify objects based on spectral properties images. The image provided to the machine learning model can reveal properties about the target object by revealing relationships between time and frequency data encoded at each pixel location. In some embodiments, the machine learning model can receive additional information during training and object classification (e.g., radar beam time of flight, temperature, air pressure, movement speed of the radar system).

The system receives, as output of the machine learning model, an object classification for the image (840). The object classification may include one or more characteristics of a target object in the environment. The target object may be located at the single point in the environment relative to the phased array module.

The predictions generated by the machine learning model can be used in a variety of ways. For example, the predicted object properties can be presented on a display device for the radar system in order to enhance the amount of information that is presented for single-point detections. As another example, the generated predictions can be used to enhance tracking processes, e.g., multi-hypothesis tracking. By using the machine learning generated predicted characteristics of the object, including size, shape, orientation, or aircraft type, multiple hypotheses in such processes can be confirmed or discarded in new ways that greatly increases the accuracy and power of such processes.

The predictive model may be built using machine learning techniques. In some cases, one or more physical characteristics of a target object such as the materials, physical composition or volumetric/geometric composition (e.g., laminated plastic/metal bumpers, tires, etc.), position and/or polarization signature of the target can be determined in real-time with aid of the machine learning model. For example, different materials, volumetric properties of a target object may cause variations in the amplitude and/or phase information of the return signals.

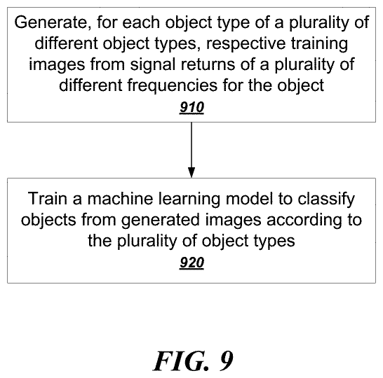

FIG. 9 is a flowchart of an example process for training a machine learning model to derive information from spectral properties of images. The example process can be performed by a system having one or more computers that is programmed in accordance with this specification to process radar signal data. For convenience, the process will be described as being performed by a system of one or more computers.

The predictive model may be trained using iterative learning cycles or updated dynamically using external data sources. The input data/vector supplied to the machine learning model can be raw signals. Alternatively or in addition to, the input data supplied to the machine learning model can be processed data such as the time delay, phase, polarization, intensity/amplitude extracted from the raw signals. The input data supplied to the machine learning model can include the images constructed by the system as described above. The output data of the machine learning model may be the one or more properties of an object as described above. The output data can be other inferences or predictions according to the training datasets. In some cases, at least some of the properties of a target are obtained based on a single point measurement.

The system generates respective training images from signal returns of a plurality of different frequencies for each object type of a plurality of different object types (910). The respective training images can encode information about the properties and characteristics of the plurality of different object types. In some implementations, the training datasets can be obtained while the radar system is in operation, during a vehicle fleet or from other data sources. In the case of supervised learning, the training datasets can include ground truth data. The ground truth data may be manually or automatically labeled data or data from external data sources. In some cases, the ground truth data may be generated automatically based on data from other sensors such as camera, Lidar, infrared imaging device, ultraviolet imaging device, or any combination of different types of sensors. In some cases, training a model may involve selecting a model type (e.g., CNN, RNN, a gradient-boosted classifier or repressor, etc), selecting an architecture of the model (e.g., number of layers, nodes, ReLU layer, etc), setting parameters, creating training data (e.g., pairing data, generating input data vectors), and processing training data to create the model.

The respective training images can be grouped based on the properties or characteristics of the objects used to generate the respective training images. For example, a grouping can include images of objects classified as being located on the ground, floating on water, or located in the air. In some examples, images can be grouped based on material properties of the object (e.g., metal, fiberglass, plastic, composite, foam). In some embodiments, the groupings can be hierarchical (e.g., groupings can include sub-groupings). For example, a sub-grouping of airborne objects can include fixed wing aircraft, rotorcraft (e.g., helicopters), or lighter than air vehicles (e.g., hot air balloon). In some examples, a sub-grouping of airborne objects can include powered aircraft or unpowered aircraft (e.g., glider). In some embodiments, the sub-groupings can include further sub-groupings or subsets. For example, a sub-group of fixed wing aircraft can include unmanned aerial vehicles (UAVs), propeller planes, jumbo jets, or fighter jets.

Airborne objects can be classified in a number of ways and according to a number of different characteristics or properties. For example, airborne objects can be classified based on engine type, number of engines, or engine size. For example, the engine type can include propeller (e.g. front, back), jet (e.g., unobscured compressor blades, obscuring air inlet). In some embodiments, airborne objects can be classified based wing configuration (e.g., wing sweep, aspect ratio, presence of winglets), tail configuration (e.g., location and/or number of vertical and horizontal stabilizers), or landing gear (e.g., fixed landing gear, retracted landing gear). Thus, the system can use real or simulated aircraft types in order to generate spectral property images for each of the different selected classifications.

Objects can also be classified according to their orientation. In other words, from an image generated from radar returns, the trained model can generate information representing an orientation of the object in a reference frame. In order to train a model to learn orientation information, in some implementations, training images can be generated for the different object types for each of a plurality of different orientations of the object. For example, different surfaces and profiles of the objects can be presented in each of the plurality of different orientations, e.g., front, back, side, top, bottom, askew. The original orientations can be used as labeled training examples in order to train the model to learn orientations from images of generated radar returns.

In some implementations, training images can be generated for the different object types based on various distances to the object (e.g., based on radar beam time of flight), and various movement speeds (e.g., based on frequency shift) of the object relative to the radar system. For example, the training images can encode information representing the frequency shift and intensity of the radar return.

In some implementations, data can be input into different layers of the machine learning model. For example, the image can be split into at least two sections, and each section can be provided to a different layer (e.g., parallel layers, sequential layers) of the model. In some examples, the left half of the image (e.g., received before the center of the radar return) and the fight half of the image (e.g., received after the center of the radar return) can be input into separate layers of the model. In some embodiments, one layer of the model can receive the image as input, and a different layer can receive additional information (e.g., radar beam time of flight, temperature, air pressure, movement speed of the radar system). The output of the different layers of the model can be combined as an input for another layer of the model.

In some implementations, multiple machine learning models can be trained to classify objects. For example, different models can be trained for different groupings of objects. In some examples, different models can be trained for classifying objects at different distances. The different models can be trained with images of the object types at various distances (e.g., close, intermediate, far).

In some implementations, multiple machine learning models can be used in sequence. For example, a first model can provide a coarse classification of the object. A second model can be selected to provide a fine (e.g., more specific, narrower, absolute) classification based on the output of the first model.

In some implementations, the training images can be obtained from computer generated images. For example, radar returns for different object types can be simulated by using graphical rendering techniques (e.g., ray tracing). In some examples, simulated radar returns can be obtained from machine learning models trained to generate images corresponding to objects with specific features.

The system trains a machine learning model using the generated training images (920). The system can use any appropriate machine learning model for classifying the generated spectral properties images. Machine learning algorithms (artificial intelligence) may be used to train a predictive model for determining one or more properties or characteristics of the target object or spot in the environment. A machine learning algorithm may be a neural network, for example. Examples of neural networks include a deep neural network, convolutional neural network (CNN), and recurrent neural network (RNN). The machine learning algorithm may comprise one or more of the following: a support vector machine (SVM), a naïve Bayes classification, a linear regression, a quantile regression, a logistic regression, a random forest, a neural network, CNN, RNN, a gradient-boosted classifier or repressor, or another supervised or unsupervised machine learning algorithm.

Methods and systems of the present disclosure can be implemented by way of one or more algorithms. An algorithm can be implemented by way of software upon execution by an external processing unit or the signal analysis module. Methods and modules of the present disclosure can be implemented by software, hardware or a combination of both.

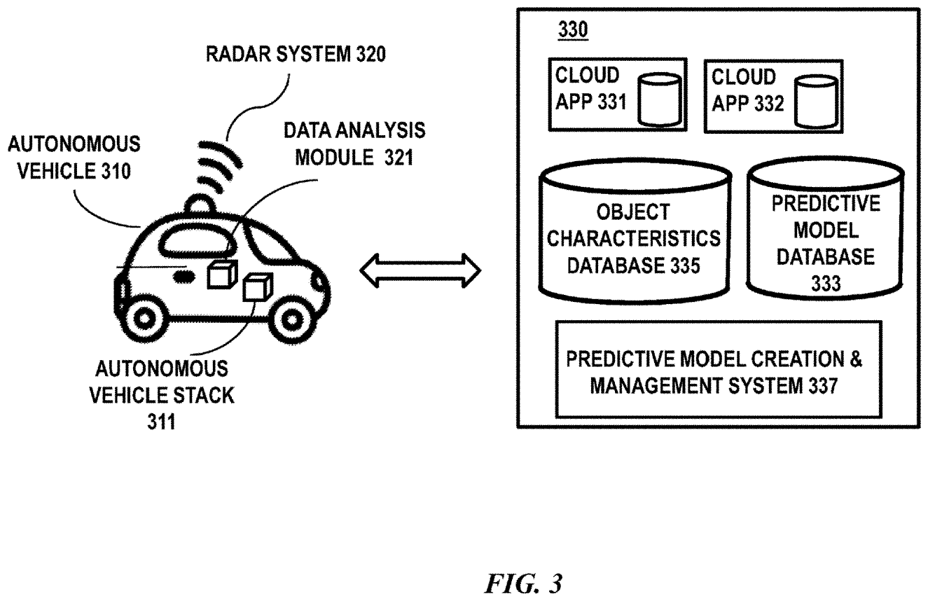

FIG. 3 schematically illustrates a radar system 320 configured to provide an enriched 3D point cloud and perform single point object recognition for an autonomous vehicle 310. A signal analysis module 321 may be local to or onboard the radar system 320 or an autonomous vehicle 310 the radar system is mounted to. The data analysis module 321 can be the same as the data analysis module as described in FIG. 1. Data or information generated by the data analysis module 321 can be delivered to a remote entity 330, a third-party entity, or be utilized by the autonomous vehicle stack 311. The data analysis module 321 can be a component of the radar system 320, a component of the autonomous vehicle stack 311 or a standalone system.

An autonomous vehicle 310 may be an automated vehicle. Such automated vehicle may be at least partially or fully automated. An autonomous vehicle may be configured to drive with some or no intervention from a driver or passenger. An autonomous vehicle may travel from one point to another without any intervention from a human onboard the autonomous vehicle. In some cases, an autonomous vehicle may refer to a vehicle with capabilities as specified in the National Highway Traffic Safety Administration (NHTSA) definitions for vehicle automation, for example, Level 4 of the NHTSA definitions (L4), “an Automated Driving System (ADS) on the vehicle can itself perform all driving tasks and monitor the driving environment—essentially, do all the driving—in certain circumstances. The human need not pay attention in those circumstances,” or Level 5 of the NHTSA definitions (LS), “an Automated Driving System (ADS) on the vehicle can do all the driving in all circumstances. The human occupants are just passengers and need never be involved in driving.” It should be noted that the provided systems and methods can be applied to vehicles in other automation levels. For example, the provided systems or methods may be used for managing data generated by vehicles satisfying Level 3 of the NHTSA definitions (L3), “drivers are still necessary in level 3 cars, but are able to completely shift safety-critical functions to the vehicle, under certain traffic or environmental conditions. It means that the driver is still present and will intervene if necessary, but is not required to monitor the situation in the same way it does for the previous levels.” The autonomous vehicle data may also include data generated by automated vehicles.

An autonomous vehicle may be referred to as an unmanned vehicle. The autonomous vehicle can be an aerial vehicle, a land vehicle, or a vehicle traversing a body of water. The autonomous vehicle can be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle or a train), under the ground (e.g., a subway), in space (e.g., a spaceplane, a satellite, or a probe), or any combination of these environments.

An autonomous vehicle stack 311 may consolidate multiple domains, such as perception, data fusion, cloud/OTA, localization, behavior (a.k.a. driving policy), control and safety, into a platform that can handle end-to-end automation. For example, an autonomous vehicle stack may include various runtime software components or basic software services such as perception (e.g., ASIC, FPGA, GPU accelerators, SIMD memory, sensors/detectors, such as cameras, Lidar, radar, GPS, etc.), localization and planning (e.g., data path processing, DDR memory, localization datasets, inertia measurement, GNSS), decision or behavior (e.g., motion engine, ECC memory, behavior modules, arbitration, predictors), control (e.g., lockstep processor, DDR memory, safety monitors, fail safe fallback, by-wire controllers), connectivity, and I/O (e.g., RF processors, network switches, deterministic bus, data recording). The raw radar data or processed radar data produced by the radar system 320 or the data analysis module 321 may be delivered to the autonomous vehicle stack for various applications as described above.

In some cases, the raw radar data or processed radar data may further be delivered to and used by a user experience platform which may include user experience applications such as digital services (e.g., access to music, videos or games), transactions, and passenger commerce or services.

As described above, the data analysis module 321 may perform functions such as object recognition, determining one or more characteristics/signatures of a target object with the aid of a machine learning model. In some cases, one or more physical characteristics of a target object such as the materials or volumetric/geometric composition (e.g., laminated plastic/metal bumpers, tires, etc) can be determined by the machine learning model. The machine learning model may be trained to determine and identify a target at different understanding levels, which may include, by way of example, dimensions, weight, composition, identity, degree of threat and so forth. For example, the machine learning model may be trained to recognize an identity of target objects (e.g. wheelbarrow upright), determine a classification of types of target objects, and impact severity/threat level (e.g. metal, large object that has higher threat vs. cardboard box, hollow that has lower threat).

The data analysis module 321 may be implemented as a hardware accelerator, software executable by a processor and various others. In some embodiments, the provided data analysis module may employ an edge intelligence paradigm that data processing and prediction is performed at the edge or edge gateway. In some instances, machine learning models may be built, developed and trained on a cloud/data center 330 and run on the vehicle or the radar system (e.g., hardware accelerator).

The data analysis module or a portion of the data analysis module may be implemented on an edge intelligence platform. For example, the predictive model may be a software-based solution based on fog computing concepts which extends data processing and prediction closer to the edge (e.g., radar system). Maintaining close proximity to the edge devices (e.g., autonomous vehicle, sensors) rather than sending all data to a distant centralized cloud, minimizes latency allowing for maximum performance, faster response times, and more effective maintenance and operational strategies. It also significantly reduces overall bandwidth requirements and the cost of managing widely distributed networks. The provided data analysis module may employ an edge intelligence paradigm that at least a portion of data processing can be performed at the edge. In some instances, the machine learning model or object recognition may be built, developed, trained, maintained on the cloud, and run on the edge device or radar system (e.g., hardware accelerator).

The data analysis module may be implemented in software, hardware, firmware, embedded hardware, standalone hardware, application specific-hardware, or any combination of these. The data analysis module and its components, edge computing platform, and techniques described herein may be realized in digital electronic circuitry, integrated circuitry, specially designed ASICs (application specific integrated circuits), computer hardware, firmware, software, and/or combinations thereof. These systems, devices, and techniques may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, and/or device (such as magnetic discs, optical disks, memory, or Programmable Logic Devices (PLDs)) used to provide machine instructions and/or data to a programmable processor.

In some embodiments, the software stack of the radar data analysis can be a combination of services that run on the edge and cloud. Software or services that run on the edge may provide a machine learning model-based predictive model for object recognition, object detection, threat detection and various others as described elsewhere herein. Software or services that run on the cloud may provide a predictive model creation and management system 337 for training, developing, and managing predictive models.

In some cases, the radar system 320 or the data analysis module 321 may also comprise a data orchestrator that may support ingesting of radar data into a local storage repository (e.g., local time-series database), data cleansing, data enrichment (e.g., decorating data with metadata, decorating 3D point cloud data with target signature data), data alignment, data annotation, data tagging, or data aggregation. In some cases, raw radar data or processed radar data may be aggregated across a time duration (e.g., about 1, 2, 3, 4, 5, 6, 7, 8, 9, 10 seconds, about 1, 2, 3, 4, 5, 6, 7, 8, 9, 10 minutes, about 1, 2, 3, 4, 5, 6, 7, 8, 9, 10 hours, etc) to be transmitted to the cloud 330 or other third-party entities. Alternatively or in addition, raw radar data or processed radar data can be aggregated with data from other sensors/sources and sent to a remote entity (e.g., third-party partner server) as a package.

The predictive model creation and management system 337 may include services or applications that run in the cloud or an on-premises environment to remotely configure and manage the data analysis module 321. This environment may run in one or more public clouds (e.g., Amazon Web Services (AWS), Azure, etc.), and/or in hybrid cloud configurations where one or more parts of the system run in a private cloud and other parts in one or more public clouds. For example, the predictive model creation and management system 337 may be configured to train and develop predictive models and deploy the models to the data analysis module 321 or the edge infrastructure. The predictive model creation and management system 337 may also support ingesting radar data transmitted from the radar system into one or more databases or cloud storages 333, 335. The predictive model creation and management system 130 may include applications that allow for integrated administration and management, including monitoring or storing of data in the cloud or at a private data center.

The data center or remote entity 330 may comprise one or more repositories or cloud storage for storing object signatures/characteristics identified based on radar data and for storing machine learning models. For example, a data center 330 may comprise a predictive model database 333 and a library 335 for storing processed radar data such as object signatures/characteristics. The library can for example include data characterizing a plurality of different object classes.

Alternatively or in addition to, the object characteristic database 335 may be local to the autonomous vehicle or the radar system 320.

The cloud databases 333, 335 and local database of the disclosure may utilize any suitable database techniques. For instance, a structured query language (SQL) or “NoSQL” database may be utilized for storing the radar data, object classification, characteristics, historical data, predictive model or algorithms. Some of the databases may be implemented using various standard data-structures, such as an array, hash, (linked) list, struct, structured text file (e.g., XML), table, JavaScript Object Notation (JSON), NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. In some embodiments, the database may include a graph database that uses graph structures for semantic queries with nodes, edges and properties to represent and store data. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

The cloud applications 331, 332 may further process or analyze data transmitted from the radar system for various use cases. The cloud applications may allow for a range of use cases for pilotless/driverless vehicles in industries such as original equipment manufacturers (OEMs), hotels and hospitality, restaurants and dining, tourism and entertainment, healthcare, service delivery, and various others. In particular, the provided data management systems and methods can be applied to data related to various aspects of the automotive value chain including, for example, vehicle design, test, and manufacturing (e.g., small batch manufacturing and the productization of autonomous vehicles), creation of vehicle fleets that involves configuring, ordering services, financing, insuring, and leasing a fleet of vehicles, operating a fleet that may involve service, personalization, ride management and vehicle management, maintaining, repairing, refueling and servicing vehicles, and dealing with accidents and other events happening to these vehicles or during a fleet.

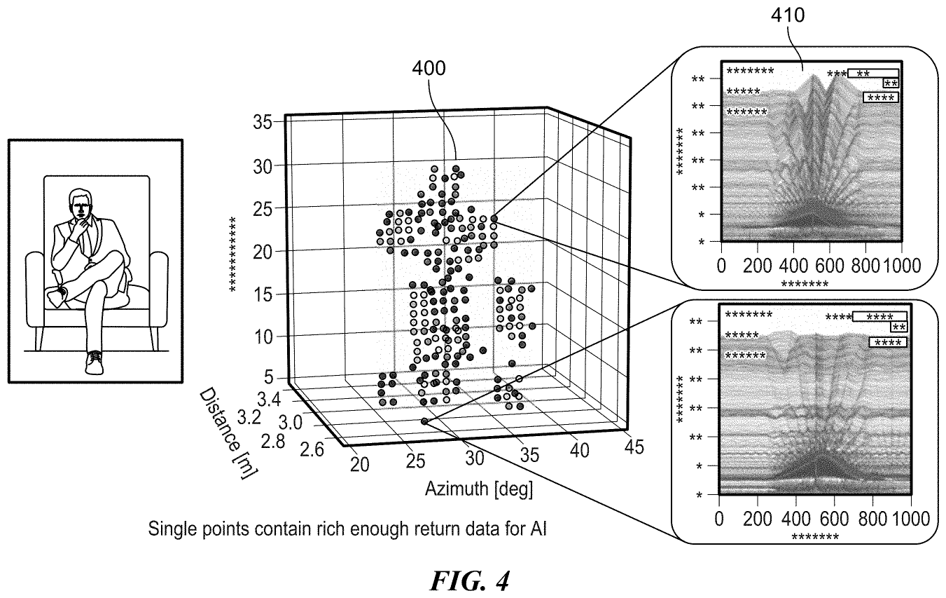

FIG. 4 shows an example of object recognition using single point data. The term “single point data” may be referred to as single point measurement data which can be used interchangeably throughout this specification. As shown in the point cloud image 400, in addition to the 3D image data which contains information about the location, size of a target, object signatures 410 such as materials or physical properties of each single point can also be generated. Such materials or physical properties may be generated by the predictive model as described above. The 3D point cloud data may be enriched by data generated by the predictive model that one or more points in the point cloud image may be supplemented by the information generated using the predictive model. For instance, material of each point may be identified by the predictive model.

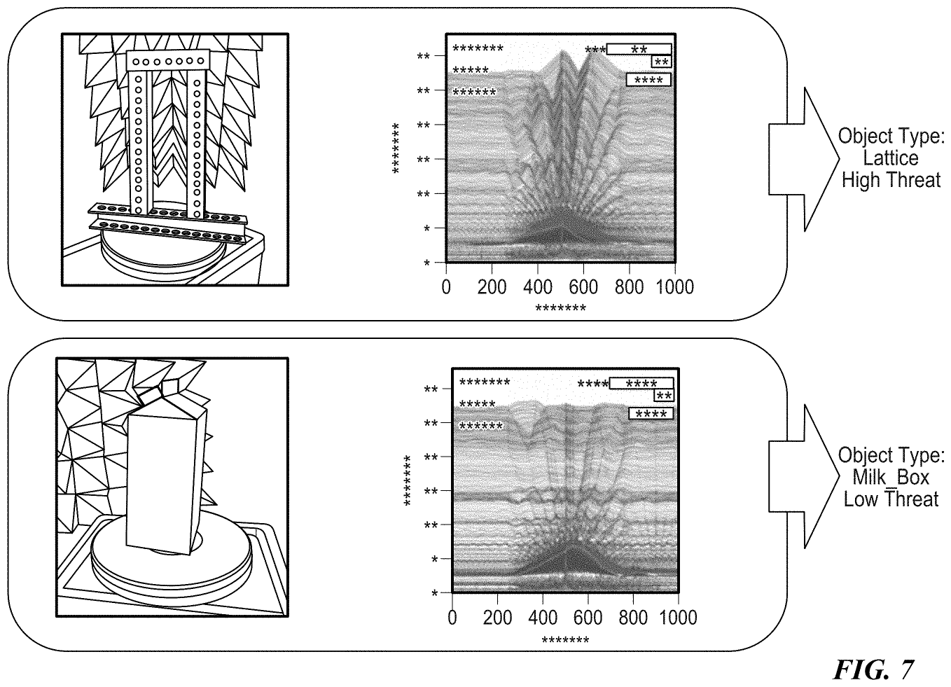

FIG. 7 shows an example of performing threat detection using the provided predictive model. In some cases, one or more characteristics of an object (e.g., material, size, identity) may be determined by the machine learning model as well as a corresponding threat level.

The provided radar system is capable of producing a large amount of radar data that contains valuable information and can be utilized for various purposes. In some cases, the radar system can produce more than 1 terabytes (TB) of raw data per second. The significant amount of radar data can be valuable and may be needed to be identified, selected, and processed to be used for extracting important information.

In some cases, an automated pipeline engine may be provided for processing the radar data. The pipeline engine may comprise multiple components or layers. The pipeline engine may be configured to preprocess continuous streams of raw radar data or batch data transmitted from a radar system. In some cases, data may be processed so it can be fed into machine learning analyses. In some cases, data may be processed to provide details at different understanding levels, which understanding may include, by way of non-limiting example, dimensions, weight, composition, identity, degree of threat and so forth. In some cases, the pipeline engine may comprise multiple components to perform different functions for extracting different levels of information from the radar data. In some cases, the pipeline engine may further include basic data processing such as, data normalization, labeling data with metadata, tagging, data alignment, data segmentation, and various others. In some cases, the processing methodology is programmable through APIs by the developers constructing the pipeline.

In some embodiments, the pipeline engine may utilize machine learning techniques for processing data. In some embodiments, raw radar data may be supplied to the first layer of the pipeline engine which may employ a deep learning architecture to extract primitives, such as edges, corners, surfaces, of one or more target objects. In some cases, the deep learning architecture may be a convolutional neural network (CNN). CNN systems commonly are composed of layers of different types: convolution, pooling, upscaling, and fully-connected neural networks. In some cases, an activation function such as a rectified linear unit may be used in some of the layers. In a CNN system, there can be one or more layers for each type of operation. The input data of the CNN system may be the data to be analyzed such as 3D radar data. The simplest architecture of a convolutional neural networks starts with an input layer (e.g., images) followed by a sequence of convolutional layers and pooling layers, and ends with fully-connected layers. In some cases, the convolutional layers are followed by a layer of ReLU activation function. Other activation functions can also be used, for example the saturating hyperbolic tangent, identity, binary step, logistic, arcTan, softsign, parametric rectified linear unit, exponential linear unit. softPlus, bent identity, softExponential, Sinusoid, Sine, Gaussian, the sigmoid function and various others. The convolutional, pooling and ReLU layers may act as learnable features extractors, while the fully connected layers acts as a machine learning classifier.

In some cases, the convolutional layers and fully-connected layers may include parameters or weights. These parameters or weights can be learned in a training phase. The parameters may be trained with gradient descent so that the class scores that the CNN computes are consistent with the labels in the training set for each 3D point cloud image. The parameters may be obtained from a back propagation neural network training process that may or may not be performed using the same hardware as the production or application process.

A convolution layer may comprise one or more filters. These filters will activate when they see the same specific structure in the input data. In some cases, the input data may be 3D images, and in the convolution layer one or more filter operations may be applied to the pixels of the image. A convolution layer may comprise a set of learnable filters that slide over the image spatially, computing dot products between the entries of the filter and the input image. The filter operations may be implemented as convolution of a kernel over the entire image. A kernel may comprise one or more parameters. Results of the filter operations may be summed together across channels to provide an output from the convolution layer to the next pooling layer. A convolution layer may perform high-dimension convolutions. For example, the three-dimensional feature maps or input 3D data are processed by a group of three-dimensional kernels in a convolution layer.

The output produced by the first layer of the pipeline engine may be supplied to a second layer which is configured to extract understanding of a target object such as shapes, materials, subsurface structure, or interpret ground-penetrating measurements. In some cases, the second layer can also be implemented using a machine learning architecture.

The output produced by the second layer may then be supplied to a third layer of the pipeline engine which is configured for perform interpretations and decision makings, such as object recognition, separation, segmentation, determination of materials, target dynamics (e.g., vehicle inertia, direction), remote sensing, threat detection, identify recognition, type classification and the like.

The pipeline engine described herein can be implemented by one or more processors. In some embodiments, the one or more processors may be a programmable processor (e.g., a central processing unit (CPU), a graphic processing unit (GPU), a general-purpose processing unit or a microcontroller), in the form of fine-grained spatial architectures such as a field programmable gate array (FPGA), an application-specific integrated circuit (ASIC), and/or one or more Advanced RISC Machine (ARM) processors. In some embodiments, the processor may be a processing unit of a computer system.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used herein A and/or B encompasses one or more of A or B, and combinations thereof such as A and B. It will be understood that although the terms “first,” “second,” “third” etc. are used herein to describe various elements, components, regions and/or sections, these elements, components, regions and/or sections should not be limited by these terms. These terms are merely used to distinguish one element, component, region or section from another element, component, region or section. Thus, a first element, component, region or section discussed herein could be termed a second element, component, region or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions,

integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” are used herein to describe one element's relationship to other elements as illustrated in the figures. It will be understood that relative terms are intended to encompass different orientations of the elements in addition to the orientation depicted in the figures. For example, if the element in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure or the reference frame. Similarly, if the element in one of the figures were turned over, elements described as “below” or “beneath” other elements would then be oriented “above” the other elements. The exemplary terms “below” or “beneath” can, therefore, encompass both an orientation of above and below.

Reference throughout this specification to “some embodiments,” or “an embodiment,” means that a particular feature, structure, or characteristic described in connection with the embodiment is included in at least one embodiment. Thus, the appearances of the phrase “in some embodiment,” or “in an embodiment,” in various places throughout this specification are not necessarily all referring to the same embodiment. Furthermore, the particular features, structures, or characteristics may be combined in any suitable manner in one or more embodiments

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A radar system comprising:
a phased array module configured to transmit a sequence of pulses to an environment according to a pre-determined pattern; and
one or more processors and one or more storage devices storing instructions that when executed by the one or more processors cause the one or more processors to (i) construct an image based on returned signals from a single point received by the phased array module, and (ii) determine one or more characteristics of a target object in the environment based on the image constructed from the returned signals from the single point.

2. The radar system of claim 1, wherein the image has two dimensions representing a sample number and a frequency.

3. The radar system of claim 1, wherein constructing the image based on the returned signals comprises:
generating the image from a return characteristic for each combination of a representation for a plurality of frequencies and a representation for time durations.

4. The radar system of claim 3, wherein the return characteristic is a measure of signal strength.

5. The radar system of claim 3, wherein the representations of the plurality of frequencies comprise a frequency index representing a frequency within a frequency range.

6. The radar system of claim 3, wherein the representation for the time durations comprises sample numbers.

7. The radar system of claim 1, wherein determining the one or more characteristics of the target object based on the image comprises:
providing the image as input to a trained machine learning model configured to classify objects; and
receiving, as output from the trained machine learning model, an object classification for the target object.

8. The radar system of claim 7, wherein the object classification for the target object represents an object type, an object size, object dimensions, a material type, or a threat level.

9. The radar system of claim 7, wherein the trained machine learning model is trained on a library of object classes.

10. A method comprising:
receiving, by a phased array module, signals returned from a sequence of pulses transmitted into an environment according to a pre-determined pattern;
constructing, by a system of one or more computers, an image based on the returned signals from a single point received by the phased array module; and
determining one or more characteristics of a target object in the environment based on the image constructed from the returned signals from the single point.

11. The method of claim 10, wherein the image has two dimensions representing a sample number and a frequency.

12. The method of claim 10, wherein constructing the image based on the returned signals comprises:
generating the image from a return characteristic for each combination of a representation for a plurality of frequencies and a representation for time durations.

13. The method of claim 12, wherein the return characteristic is a measure of signal strength.

14. The method of claim 12, wherein the representations of the plurality of frequencies comprise a frequency index representing a frequency within a frequency range.

15. The method of claim 12, wherein the representation for the time durations comprises sample numbers.

16. The method of claim 10, wherein determining the one or more characteristics of the target object based on the image comprises:
providing the image as input to a trained machine learning model configured to classify objects; and
receiving, as output from the trained machine learning model, an object classification for the target object.

17. The method of claim 16, wherein the object classification for the target object represents an object type, an object size, object dimensions, a material type, or a threat level.

18. The method of claim 16, wherein the trained machine learning model is trained on a library of object classes.

19. A radar system comprising:
a phased array module configured to transmit a sequence of pulses to an environment according to a pre-determined pattern ; and
one or more processors electrically coupled to the phased array module, wherein the one or more processors are configured to: (i) construct a point cloud image based on returned signals received by the phased array module; and (ii) determine one or more characteristics of a target object in the environment based on data corresponding to a single point in the point cloud image.
